(19) United States
(12) Patent Application Publication
(10) Pub. No.: US 2009/0114877 A1
(43) Pub. Date: May 7, 2009

(54) Composition Containing Stability-Improved Chloromethyl Phosphate Derivatve and Process for Producing Same

(75) Inventors: Shigeto Negi, Ibaraki (JP); Mamoru Miyazawa, Ibaraki (JP)

Correspondence Address: BIRCH STEWART KOLASCH & BIRCH, PO BOX 747, FALLS CHURCH, VA, 22040-0747, US

(73) Assignee: Eisai R&D Management Co., Ltd., Tokyo (JP)

(21) Appl. No.: 11/991,603

(22) PCT Filed: Sep. 8, 2006
(86) PCT No.: PCT/JP2006/317823

§ 371 Date: Mar. 7, 2008

(30) Foreign Application Priority Data
Sep. 13, 2005 (JP) 2005-266055

(51) Int. Cl. C09K 3/00

(52) U.S. Cl. 252/182.29

(57) ABSTRACT

The present invention provides a production process or the like, which is a process for producing a chloromethyl phosphate derivative useful for producing a water-soluble prodrug, and which is excellent from the points of view of workability, operativity and energy saving. According to the present invention, there is provided a process for producing a composition containing a compound represented by the following Formula (I) and a tertiary amine,

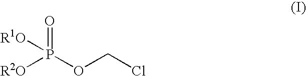

(wherein R1 and R2 are identical or different from each other, and represent a C1-C6 alkyl group, a C2-C6 alkenyl group or a C6-C14 aryl C1-C6 alkyl group which may have a substituent, and R1 and R2 may together form a ring), the process comprising adding the tertiary amine to the compound represented by Formula (I).

### TECHNICAL FIELD

The present invention relates to a chloromethyl phosphate derivative for producing a water-soluble prodrug, and more specifically, to a composition containing a tertiary amine and the chloromethyl phosphate derivative and having improved storage stability, and a process for producing the same, as well as a method for stabilizing chloromethyl phosphate derivative.

### BACKGROUND ART

The compound represented by the following formula is known as one example of water-soluble prodrug, (for example, refer to Patent Reference 1). This compound is a water-soluble azole compound that is useful in the treatment of serious systemic fungal infection.

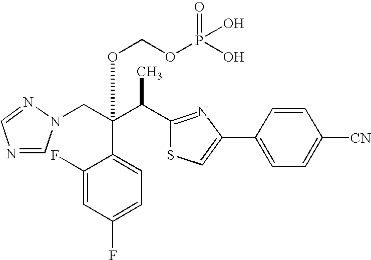

In addition, this water-soluble azole compound is also known to be producible via the following scheme (refer to the above Patent Reference 1).

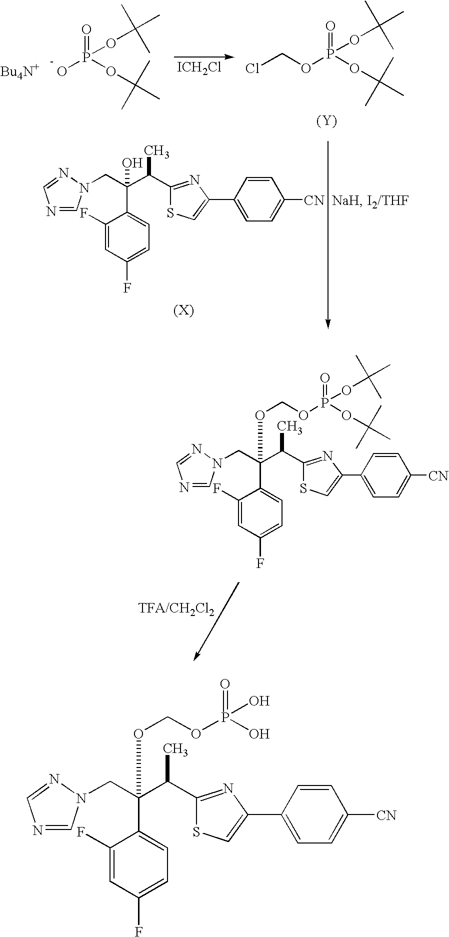

As shown in the above scheme, in order to produce the water-soluble prodrug, it is necessary for chloromethyl phosphates (corresponding to Y in the above scheme) to react with an active drug having a hydroxyl group (corresponding to X in the above scheme). Herein, the term “prodrug” means a derivative of a drug, which reverts to the original drug inside the organism. Note that, since the usefulness of the drug is limited by the extent of water-solubility thereof, converting an active drug into a water-soluble prodrug often becomes a subject of research and development.

However, when producing the water-soluble azole compound according to the above reaction scheme, difficulties are expected to arise in the industrial production in particular of the water-soluble azole compounds, from the facts that (1) there are concerns on the stable supply of tetrabutyl ammonium di-tert-butyl phosphate, a compound serving as the source of chloromethyl phosphate (Y) and that (2) highly toxic chloroiodomethane is used.

Meanwhile, other processes for producing the chloromethyl phosphate derivative (Y) are also known (for example, refer to Non-patent Reference 1). In this Non-patent Reference 1, it is disclosed that a dialkyl or dibenzyl chloromethyl phosphate derivative can be produced by using, dialkyl or dibenzyl phosphate and chloromethyl chlorophosphate as raw materials in the presence of a phase-transfer catalyst in a water-chloromethane mixed solvent.

However, since the halogen-based solvents has to be used absolutely in the production process of the Non-patent Reference 1, in order to achieve an industrial application thereof, there will be an important burden on the environment, also accompanied by the complexity of waste liquid treatment. Therefore, the production process disclosed in the Non-patent Reference 1 does not qualify as an excellent production process from the points of view of workability, operativity and energy saving, and is not realistic as an industrial production method of the chloromethyl phosphate derivative.

### [Patent Reference 1] Japanese Unexamined Patent Application Publication No. 2004-518640

### [Non-patent Reference 1] Antti Mantyla et al., Tetrahedron Letters 43 (2002) 3793-3794

### DISCLOSURE OF INVENTION

### Problems to be Solved by the Invention

An object of the present invention is to provide, in regard to the chloromethyl phosphate derivative that is useful in the production of the water-soluble prodrug, a process for producing the chloromethyl phosphate derivative having excellent workability, operativity and energy saving without using a highly toxic reagent.

### Means for Solving the Problems

Thus, the present inventors, in view of the aforementioned issues, conducted earnest studies on a process for producing the chloromethyl phosphate derivatives and as a result established a production process that excels in workability, and the like, and at the same time, discovered that, in fact, the chloromethyl phosphate derivative per se was unstable, obtained the knowledge for stabilizing the chloromethyl phosphate, and reached completion of the present invention.

That is to say, in the first aspect of the present invention, there is provided a composition comprising:

(A) a compound represented by the following Formula (I); and

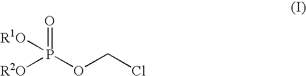

(wherein R1 and R2 are identical or different from each other, and represent a C1-C6 alkyl group, a C2-C6 alkenyl group or a C6-C14 aryl C1-C6 alkyl group which may have a substituent, and R1 and R2 may together form a ring)

(B) a tertiary amine.

In the preferred aspect of the composition according to the present invention, the tertiary amine is trialkylamine or N-alkylmorpholine, and in the more preferred aspect, the tertiary amine is triethylamine, N,N-diisopropylethylamine or N-methyl morpholine.

Further, in the preferred aspect of the composition according to the present invention, at least 5 mol % of the tertiary amine is contained based on the compound represented by Formula (I).

Furthermore, in the preferred aspect of the composition according to the present invention, the R1 and R2 are identical or different from each other, and represent an n-butyl group, an iso-butyl group, a tert-butyl group, a vinyl group, an allyl group or a benzyl group which may have a substituent, and in the more preferred aspect, the R1 and R2 are identical or different from each other, and represent a tert-butyl group, an allyl group or a benzyl group.

In the second mode of the present invention, there is provided a process for producing a composition comprising a compound represented by the following Formula (I) and a tertiary amine,

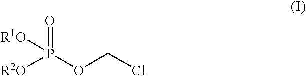

(wherein R1 and R2 are identical or different from each other, and represent a C1-C6 alkyl group, a C2-C6 alkenyl group or a C6-C14 aryl C1-C6 alkyl group which may have a substituent, and R1 and R2 may together form a ring),

the process comprising adding said tertiary amine to said compound represented by Formula (I).

According to the preferred mode of the process according to the present invention, at least 5 mol % of the tertiary amine is added based on the compound represented by Formula (I).

Further, according to the preferred mode of the process according to the present invention, the compound represented by Formula (I) is obtained by (i) reacting paraformaldehyde and chlorosulfonic acid in the presence of thionyl chloride to obtain chloromethyl chlorosulfonate, and (ii) reacting, in a solvent containing a phase-transfer catalyst and a base, the chloromethyl chlorosulfonate and the compound represented by the following Formula (II)

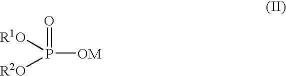

(wherein R1 and R2 are identical or different from each other, and represent a C1-C6 alkyl group, a C2-C6 alkenyl group or a C6-C14 aryl C1-C6 alkyl group which may have a substituent, R1 and R2 may together form a ring, and M represents a hydrogen atom or an alkaline metal, such as sodium or potassium).

Further, according to the preferred mode of the process according to the present invention, the solvent is an ether-based solvent, and in the more preferred mode, the ether-based solvent is cyclopentyl methyl ether or tert-butyl methyl ether.

Furthermore, according to the preferred mode of the process according to the present invention, the phase-transfer catalyst is tetrabutylammonium hydrogen sulfate, and the base is dipotassium hydrogen phosphate or sodium bicarbonate.

Moreover, according to the preferred mode of the process according to the present invention, the tertiary amine is trialkylamine or N-alkylmorpholine, and in the more preferred mode, the tertiary amine is triethylamine, N,N-diisopropylethylamine or N-methylmorpholine.

In addition, according to the preferred mode of the process according to the present invention, the R1 and R2 are identical or different from each other, and represent an n-butyl group, an iso-butyl group, a tert-butyl group, a vinyl group, an allyl group or a benzyl group which may have a substituent, and in the more preferred mode, the R1 and R2 are identical or different from each other, and represent a tert-butyl group, an allyl group or a benzyl group.

According to the third mode of the present invention, there is provided a method for stabilizing a compound represented by the following Formula (I):

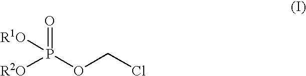

(wherein R1 and R2 are identical or different from each other, and represent a C1-C6 alkyl group, a C2-C6 alkenyl group or a C6-C14 aryl C1-C6 alkyl group which may. have a substituent, and R1 and R2 may together form a ring),

the method comprising adding a tertiary amine to said compound represented by Formula (I).

In the preferred mode of the stabilization method according to the present invention, at least 5 mol % of the tertiary amine is added based on the compound represented by Formula (I).

Further, according to the preferred mode of the stabilization method according to the present invention, the tertiary amine is trialkylamine or N-alkylmorpholine, and in the more preferred mode, the tertiary amine is triethylamine, N,N-diisopropylethylamine or N-methylmorpholine.

Furthermore, according to the preferred mode of the stabilization method according to the present invention, the R1 and R2 are identical or different from each other, and represent an n-butyl group, an iso-butyl group, a tert-butyl group, a vinyl group, an allyl group or a benzyl group which may have a substituent, and in the more preferred mode, the R1 and R2 are identical or different from each other, and represent a tert-butyl group, an allyl group or a benzyl group.

According to the process of the present invention, the chloromethyl phosphate derivative can be produced without using highly toxic reagent or halogen-based solvent with a process that is excellent from the points of view of workability, operativity and energy saving, thus, the production process is useful industrially. In addition, according to the present invention, stabilization of chloromethyl phosphate derivative is realized by adding tertiary amine to the chloromethyl phosphate derivative applicable to the production of the water-soluble prodrug, a stable supply of said derivative becomes possible, which is beneficial to industrial production of the water-soluble prodrug.

### BRIEF DESCRIPTION OF DRAWINGS

FIG. 1 shows a figure showing the results of storage stability according to one aspect of the present invention using di-tert-butyl chlorophosphate, a circle (o) indicating that no decomposition of di-tert-butyl chlorophosphate was observed, and a cross (x) indicating that decomposition of di-tert-butyl chlorophosphate was observed in this figure; and

FIG. 2 shows a figure showing the influence on storage stability of di-tert-butyl chlorophosphate when the amount of N-methylmorpholine added was varied.

### BEST MODE FOR CARRYING OUT THE INVENTION

The following embodiment is an illustrative example for describing the present invention, and the purpose is not to limit the present invention to this embodiment only. The present invention can be carried out in a variety of modes, as long as there is no departure from the gist thereof.

The present inventor, during earnest studies on a process for producing the chloromethyl phosphate derivatives that excel in workability, and the like, without using a highly toxic reagent, obtained the knowledge that the chloromethyl phosphate derivative per se was thermally unstable, and discovered a measure to stabilize the chloromethyl phosphate derivative per se. That is to say, for the chloromethyl phosphate derivative, stabilization thereof is realized by giving it the constitution of the composition according to the present invention.

The composition according to the present invention comprises;

(A) the compound represented by the following Formula (I): and

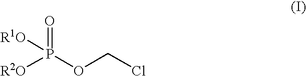

(wherein R1 and R2 are identical or different from each other, and represent a C1-C6 alkyl group, a C2-C6 alkenyl group or a C6-C14 aryl C1-C6 alkyl group which may have a substituent, and R1 and R2 may together form a ring)

(B) a tertiary amine.

In the above compound represented by Formula (I), the term “C1-C6 alkyl group” used in the present invention means a linear or branched alkyl group having a carbon number of 1 to 6. Specifically, examples of the term “C1-C6 alkyl group” include a methyl group, an ethyl group, a n-propyl group, an iso-propyl group, a n-butyl group, an iso-butyl group, a sec-butyl group, a tert-butyl group, a n-pentyl group, a 1,1-dimethyl propyl group, a 1,2-dimethyl propyl group, a 2,2-dimethyl propyl group, a 1-ethyl propyl group, a n-hexyl group, a 1-ethyl-2-methyl propyl group, a 1,1,2-trimethyl propyl group, a 1-ethyl butyl group, a 1-methyl butyl group, a 2-methyl butyl group, a 1,1-dimethyl butyl group, a 1,2-dimethyl butyl group, a 2,2-dimethyl butyl group, a 1,3-dimethyl butyl group, a 2,3-dimethyl butyl group, a 2-ethyl butyl group, a 2-methyl pentyl group, a 3-methyl pentyl group, and the like, preferably, a methyl group, an ethyl group, a n-propyl group, an iso-propyl group, a n-butyl group, an iso-butyl group, a sec-butyl group, a tert-butyl group, a n-pentyl group, and the like, more preferably, a n-butyl group, an iso-butyl group and a tert-butyl group.

The term “C2-C6 alkenyl group” used in the present invention means a linear or branched alkenyl group having a carbon number of 2 to 6, specifically, examples of he term “C2-C6 alkenyl group” include a vinyl group, an allyl group, a 1-propenyl group, an isopropenyl group, a 2-methyl-1-propenyl group, a 2-methyl-2-propenyl group, a 1-butenyl group, a 2-butenyl group, a 3-butenyl group, a 1-pentenyl group, a 1-hexenyl group, a 1,3-hexadienyl group, a 1,5-hexadienyl group, and the like, preferably, a vinyl group, an allyl group, a 1-propenyl group and isopropenyl group, and more preferably, a vinyl group and an allyl group.

The term “C6-C14 aryl C1-C6 alkyl group” in the term “C6-C14 aryl C1-C6 alkyl group which may have a substituent” used in the present invention means a group in which an arbitrary hydrogen atom of a C1-C6 alkyl group has been substituted with a C6-C14 aryl group. Herein, the term “C6-C14 aryl group” means an aryl group constituted by 6 to 14 carbon atoms and includes condensed cyclic groups, such as, monocyclic group, bicyclic group, or tricyclic group. Examples of the term “C6-C14 aryl group” include a phenyl group, an indenyl group, a naphthyl group, an azurenyl group, a heptalenyl group, a biphenyl group, an indacenyl group, an acenaphtylenyl group, a fluorenyl group, a phenalenyl group, a phenanthrenyl group, an anthracenyl group, a cyclopentacyclooctenyl group, a benzocyclooctenyl group, and the like. Examples of the term “C6-C14 aryl C1-C6 alkyl group which may have a substituent” include a benzyl group which may have a substituent, a phenethyl group which may have a substituent, a naphthyl methyl group which may have a substituent, a naphthyl ethyl group which may have a substituent, an anthracenyl methyl group which may have a substituent, an anthracenyl ethyl group which may have a substituent, and the like, preferably, a benzyl group, a phenethyl group, a naphthyl methyl group, and the like, and more preferably a benzyl group.

In addition, examples of the substituent in “which may have a substituent” of the above “C6-C14 aryl C1-C6 alkyl group which may have s substituent”, unless explicitly indicated, include:

substituent groups including (1) a halogen atom (for example, a fluorine atom, a chlorine atom, a bromine atom, an iodide atom); (2) a hydroxyl group; (3) a cyano group; (4) a nitro group; (5) a carboxyl group; (6) an oxo group; (7) an amino group; (8) a C1-C6 alkyl group (for example, a methyl group, an ethyl group, a n-propyl group, an iso-propyl group, a n-butyl group, a tert-butyl group, a n-pentyl group, a 1,1-dimethyl propyl group, a 1,2-dimethyl propyl group, a 2,2-dimethyl propyl group, a 1-ethyl propyl group, a 2-methyl butyl group, a n-hexyl group, and the like); (9) a C1-C6 alkoxy group (for example, a methoxy group, an ethoxy group, a n-propoxy group, an iso-propoxy group, a n-butoxy group, an iso-butoxy group, a sec-butoxy group, a tert-butoxy group, a n-pentyloxy group, an iso-pentyloxy group, a sec-pentyloxy group, a n-hexyloxy group, an iso-hexyloxy group, a 1,1-dimethyl propoxy group, a 1,2-dimethyl propoxy group, a 2,2-dimethyl propoxy group, and the like); (10) a C2-C6 alkenyl group (for example, a vinyl group, an allyl group, a 1-propenyl group, an isopropenyl group, a 2-methyl-1-propenyl group, a 1-butenyl group, and the like); (11) a C2-C6 alkynyl group (for example, an ethinyl group, a 1-propynyl group, a 2-propynyl group, a 1-butynyl group, a 2-butynyl group, a 3-butynyl group, a 1-ethinyl-2-propynyl group, a 1-methyl-2-propynyl group, and the like); (12) a C3-C8 cycloalkyl group (for example, a cyclopropyl group, a cyclobutyl group, a cyclopentyl group, a cyclohexyl group, a cycloheptyl group, a cyclooctyl group, and the like); (13) a C3-C8 cycloalkenyl group (for example, a cyclopropene-1-yl, a cyclopropene-3-yl, a cyclobutene-1-yl, a cyclobutene-3-yl, a 1,3-cyclobutadiene-1-yl, a cyclopentene-1-yl, a cyclopentene-3-yl, a cyclopentene4-yl, a 1,3-cyclopentadiene-1-yl, a 1,3-cyclopentadiene-2-yl, a 1,3-cyclopentadiene-5-yl, a cyclohexene-1-yl, a cyclohexene-3-yl, a cyclohexene-4-yl, a 1,3-cyclohexadiene-1-yl, a 1,3-cyclohexadiene-2-yl, a 1,3-cyclohexadiene-5-yl, a 1,4-cyclohexadiene-3-yl, a 1,4-cyclohexadiene-1-yl, and the like); (14) a C2-C7 acyl group (for example, an acetyl group, a propionyl group, a butyryl group, and the like); (15) a formyl group, and the like, and the term “which may have a substitute” means that it may have one to 5 substitute group of 1 or more species selected from the above-mentioned substituent groups.

The term “R1 and R2 may together form a ring” used in the present invention means forming a 5- to 8-membered ring (which may have a substitute and which may be saturated, partially saturated, or unsaturated) in which a phosphorus atom is contained. Examples of the term “R1 and R2 may together form a ring” include: a partial structure represented by

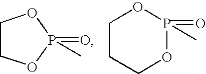

and the like.

Note that, from the point of view that the chloromethyl phosphate derivative used in the present invention reacts with an active drug having a hydroxyl group, and then is hydrolyzed to be converted into the water-soluble prodrug, the groups represented by R1 and R2 preferably represents hydroxyl group-protecting groups.

The term “tertiary amine” used in the present invention means a compound in which all three hydrogens of the ammonia have been substituted by groups other than hydrogen atoms. Examples of tertiary amines include trialkylamine, N-alkylmorpholine, di(N-alkyl)piperazine, N-alkylpiperidine, and the like. Herein, the term “alkyl” in trialkylamine, N-alkylmorpholine, di(N-alkyl)piperazine or N-alkylpiperidine means the above C1-C6 alkyl or C1-C6 cycloalkyl, which may have a substitute. Preferable examples of tertiary amines include trimethylamine, triethylamine, triethanolamine, tris(methoxyethyl)amine, tripropylamine, N,N-isopropylmethylamine, N,N-isopropylethylamine, N-methylmorpholine, N-ethylmorpholine, di(N-methyl)piperazine, di(N-ethyl)piperazine, N-methylpiperidine, N-ethylpiperidine, 1,8-diazabicyclo[5.4.0]nndeca-7-ene, 1,4-diaza bicyclo[2.2.2]octane, and the like, and more preferably, triethylamine, N,N-isopropylethylamine and N-methylmorpholine. From the point of view of long-term storage of the composition according to the present invention, tertiary amines having a high boiling point are desirable as tertiary amine used in the present invention, N,N-isobutylethylamine or N-methylmorpholine, and the like, are particularly desirable.

With respect to the above compound represented by Formula (I), at least 5 mol %, preferably at least 6 mol %, and more preferably at least 7 mol %, and even more preferably at least 10 mol % of the above tertiary amine is contained in the composition according to the present invention. By having present such amounts of tertiary amine, although the mechanism is not clear, stability during storage of the chloromethyl phosphate derivative can be ensured, allowing it to be used, as necessary, in the production of the water-soluble prodrug. Note that even in the presence of tertiary amine, the reactivity of the chloromethyl phosphate derivative per se, for example, the reactivity for the active drug having the hydroxyl group, is not affected in any way.

The composition according to the present invention can be produced by the process comprising each step shown in the following scheme.

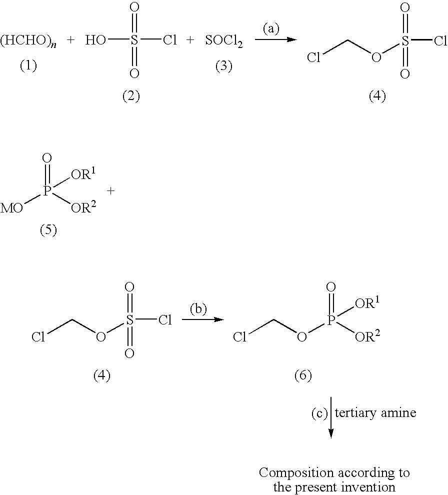

Note that in the above-mentioned scheme, R1 and R2 have the same definition as above. Further, M represents a hydrogen atom or an alkaline metal such as sodium or potassium. Furthermore, the term “room temperature” stated below means around 15 to 30° C.

Regarding Step (a)

Step (a) is a step in which Compound (1), (2) and (3) are used to produce Compound (4). Specifically, chloromethyl chlorosulfonate (Compound (4)) can be produced by reacting paraformaldehyde (Compound (1)) and chlorosulfonic acid (Compound (2)). Since paraformaldehyde is a solid at room temperature, it is hazardous when added to a reaction solution under heating. Thus, in the present step, by letting thionyl chloride (Compound (3)) coexist, the reaction in Step (a) can be allowed to proceed in a solution state, allowing desirable results, such as yield improvement, to be obtained at a reaction temperature of approximately 80° C. Note that for raw materials used in the present step, commercially available products can be used as-is.

Although the reaction temperature in the present Step (a) is not limited in particular, it is from room temperature to 85° C., and preferably from room temperature to 80° C.; although the reaction time is not limited in particular, it is in general from 1 to 20 hours, preferably from 1 hours 10 hours, and more preferably from 1 to 5 hours. Note that as reaction conditions of the present step, thionyl chloride, which is Compound (3) may be added dropwise after the Compounds (1) and (2) have been ready, or Compound (2) may be added after thionyl chloride has been added dropwise to Compound (1). After termination of the reaction in Step (a), Compound (4) can be obtained by the conventional work-up.

Regarding Step (b)

Step (b) is a step in which Compound (4) obtained in Step (a) and Compound (5) are reacted to obtain Compound (6), which is a chloromethyl phosphate derivative. In particular, although the solvent used in the present step is not limited in particular as long as it dissolves to some extent the starting materials without inhibiting the reaction, examples of the solvent include mixed solvents of water and an ether-based organic solvent, such as diethyl ether, tetrahydrofuran, 1,4-dioxane, diethoxyethane, cyclopentyl methyl ether, tert-butyl methyl ether, and the like, may be cited. From the point of view of reaction yield, preferable examples of the solvent include mixed solvent of water and cyclopentyl methyl ether, and mixed solvent of water and tert-butyl methyl ether. As described in the forgoing, from the fact that there is no need to use a halogen-based solvent in Step (b), when applied to industrial production, there is little burden on the environment, and workability is excellent. Note that commercially available products may be used as-is for the raw materials used in the present step, which can also be produced by methods well known to those skilled in the art from commercially available products. Examples of Compound (5), commercially available products can be used as-is for dibutyl phosphate and dibenzyl phosphate, diallyl phosphate can be produced according to methods described in Muller, E. In Methoden Der Organischen Chemie (Houben-Wely); Georg Thieme: Stuttgart, Germany, 1964; Vol. 12/2, pp. 286-90, and di-tert-butyl phosphate can be produced from commercially available products according to methods described in, Zwierzak, A.; Kluba, M. Tetraherdon 1971, 27, pp. 3163-3170.

In addition, in Step (b), the phase-transfer catalyst and the base are used in the above mixed solvent. Examples of the phase-transfer catalysts used in the present invention include, but are not limited to, tetrabutylammonium chloride, tetrabutylammonium hydrogen sulfate, tetrabutylphosphonium chloride, trioctylmethyl ammonium chloride, and the like, and from the point of view of reaction yield, preferably, tetrabutylammonium hydrogen sulfate. Further, examples of the bases used together with the phase-transfer catalyst in the present invention include, but are not limited to, dipotassium hydrogen phosphate, sodium bicarbonate, potassium hydrogen carbonate, and the like, and from the points of view of the solubility of the base per se and reaction yield, preferably, dipotassium hydrogen phosphate and sodium bicarbonate.

Although the reaction temperature of present Step (b) is not limited in particular, it is in general from an ice-cold to solvent reflux temperature, and preferably from an ice-cold to room temperature. Although the reaction time of the present Step (b) is not also limited in particular, it is in general from 1 to 15 hours, preferably from 1 hour to 10 hours, and more preferably from 1 hour to 5 hours.

Regarding Step (c)

The present Step (c) is a step in which tertiary amine is added to Compound (6) obtained in Step (b). As the addition method, although not limited in particular, after termination of the above Step (b), the reaction solution comprising the organic layer containing Compound (6) is washed without taking out Compound (6), tertiary amine is added, and next, the organic layer is concentrated under a reduced pressure, allowing the composition according to the present invention to be obtained. Herein, the tertiary amine used in present Step (c) is the tertiary amine with the same definition as above. Note that after termination of above Step (b), the reaction solution containing Compound (6) is washed with an aqueous solution containing the tertiary amine to be added, and then the tertiary amine is added, which is excellent for the storage stability of Compound (6). Moreover, the aqueous solution of tertiary amine to be added can also be used to wash together with an inorganic basic substance (may be a hydrate or may be an anhydride). Examples of the inorganic basic substances include, but are not limited to, trilithium phosphate, trisodium phosphate, tripotassium phosphate, lithium dihydrogen phosphate, sodium dihydrogen phosphate, dipotassium hydrogen phosphate, and the like.

As an amount of tertiary amine to be added, from the point of view of securing storage stability, at least 5 mol % based on the obtained Compound (6) is added, preferably at least 6 mol %, more preferably at least 7 mol %, and even more preferably at least 10 mol %.

Hereinafter, stabilization method according to the present invention will be described. The stabilization method according to the present invention comprises the step of adding tertiary amine to Compound (6) represented by the following Formula (I):

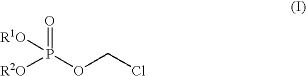

(wherein R1 and R2 have the same definitions as above). The method for adding tertiary amine is not limited in particular, as described in the above production of Compound (6), a prescribed amount of tertiary amine can be added prior to concentrating the reaction solution containing Compound (6).

From the point of view of securing storage stability, for the amount of tertiary amine to be added, at least 5 mol % is added based on Compound (6), preferably at least 6 mol %, more preferably at least 7 mol %, and even more preferably at least 10 mol %. Note that evaluation of storage stability can be carried out by calculation of peak area derived from Compound (6) by high performance liquid chromatography or calculation of integration value by P-NMR measurement before and after storage.

According to the present invention, storage stability of Compound (6) per se is improved by adding tertiary amine to Compound (6).

If there were a detrimental effect on the property of Compound (6) as reaction reagent by the addition of tertiary amine, the role as the reaction reagent would not be met. However, with the composition according to the present invention, there was no effect on the reaction with the active drug having the hydroxyl group, even if an amount of tertiary amine of 10 mol % was added based on Compound (6). Specifically, the reaction proceeded satisfactorily between (2R,3R)-3-[4-(4-cyanophenyl)thiazole-2-yl]-2-(2,4-difluorophenyl)-1-(1H-1,2,4-triazole-1-yl)-butane-2-ol having a tertiary hydroxyl group (refer to the following chemical formula) disclosed in U.S. Pat. No. 5,648,372 and a compound containing di-tert-butyl chloromethyl phosphate, which is one of Compound (6), and N-methylmorpholine, readily carrying out the introduction of a phosphate.

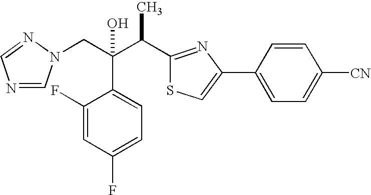

### EXAMPLES

Hereinafter, the present invention will be described more specifically by showing examples and the like; however these descriptions are illustrative examples, and the present invention is not limited thereto in any way.

### Example 1

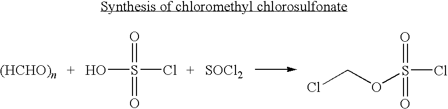

Paraformaldehyde (10 g) was added to a 100 mL four-neck flask and stirred in an ice-cooled water bath. Chlorosulfonic acid (24 mL) was added thereto dropwise at an internal temperature of 80° C. or lower, and after stirring at room temperature for one hour, thionyl chloride (22 mL) was added thereto dropwise. After termination of the dropwise addition, the reaction solution was heated at 60° C. for three hours, and then cooled. The reaction solution was added dropwise to ice water (400 mL), and liquid separation was carried out. After washing with water, MgSO₄ was added to the organic layer, dilution was carried out with the same amount of hexane as the organic layer, and filtration was carried out. The filtrate was concentrated under a reduced pressure, resulting residue was distilled under a reduced pressure to obtain 15 g of the title compound as a colorless clear liquid. (BP: 50 to 60° C./18 to 20 mmHg) (yield: 30%)

### Example 2

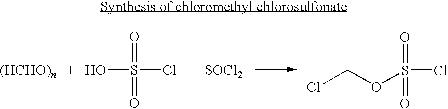

Paraformaldehyde (10 g) was added to a 200 mL four-neck flask and stirred in an ice-cooled water bath. Thionyl chloride (22 mL) was added thereto dropwise, and then, chlorosulfonic acid (24 mL) was added thereto dropwise. After stirring at room temperature for four hours, the reaction solution was heated at 60° C. for 14 hours, and then cooled. The reaction solution was added dropwise to ice water (400 mL), and liquid separation was carried out. After washing with water, MgSO₄ was added to the organic layer, dilution was carried out with the same amount of hexane as the organic layer, and filtration was carried out. After concentration under a reduced pressure, the resulting residue was distilled under a reduced pressure to obtain 7.9 g of the title compound as a colorless clear liquid. (BP: 54° C./15 mmHg) (yield: 16%)

### Example 3

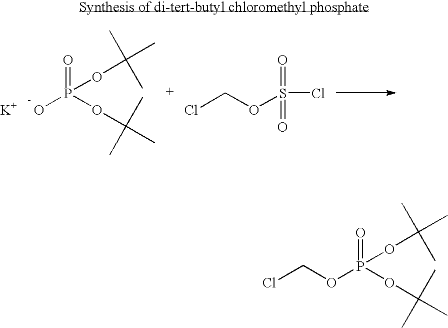

A 500 mL four-neck round bottom flask was equipped with a mechanical stirrer and a thermometer; under a nitrogen streaming, potassium di-tert-butyl phosphate (24 g), dipotassium hydrogen phosphate (66.3 g), tetrabutylammonium hydrogen sulfate (3.23 g), tert-butyl methyl ether (112 mL) and water (84 mL) were added, and stirred while cooling with an ice bath. At an internal temperature of 15° C., a solution of chloromethyl chlorosulfonate (23.5 g) dissolved in tert-butyl methyl ether (23.6 mL) was added thereto dropwise over two hours at an internal temperature of 30° C. or lower. After dropwise addition was terminated, stirring was carried out for two hours, water (84 mL) and tert-butyl methyl ether (112 mL) were added to a separating funnel, and the above-mentioned reaction solution was added thereto. The lower layer was discarded the organic layer was washed with an aqueous solution of 2M dipotassium hydrogen phosphate (84 mL), an aqueous solution of N-methylmorpholine (prepared from 1.05 mL of N-methylmorpholine and 84 mL of water), and water, then, N-methylmorpholine (1.05 mL) was added thereto, the organic layer was concentrated in a bath set 35° C. under a reduced pressure to obtain 20 g of the title compound. (yield: 80%)

Note that the amount of N-methylmorpholine added last was 10 mol % based on di-tert-butyl chloromethyl phosphate, and a composition containing the title compound and N-methylmorpholine was obtained.

### Example 4

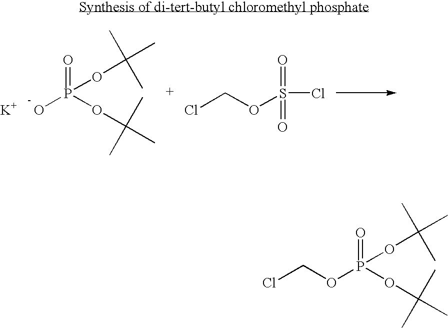

A 200 mL four-neck round bottom flask was equipped with a mechanical stirrer and a thermometer; under nitrogen streaming, potassium di-tert-butyl phosphate (6 g), dipotassium hydrogen phosphate (17.5 g), tetrabutylammonium hydrogen sulfate (0.85 g), tert-butyl methyl ether (35 mL) and water (26 mL) were added, and stirred while cooling with an ice bath. At an internal temperature of 15° C., a solution of chloromethyl chlorosulfonate (6.2 g) dissolved in tert-butyl methyl ether (6.2 mL) was added thereto dropwise over two hours at an internal temperature of 30° C. or lower. After dropwise addition was terminated, stirring was carried out for two hours, water (26 mL) and tert-butyl methyl ether (35 mL) were added to a separating funnel, and the above-mentioned reaction solution was added thereto. The lower layer was discarded, the organic layer was washed with water (26 mL), then, N-methylmorpholine (0.27 mL) was added, and the organic layer was concentrated in a bath set 35° C. under a reduced pressure to obtain 5.5 g of the title compound. (yield: 85%)

Note that the amount of N-methylmorpholine added last was 5 mol % based on di-tert-butyl chloromethyl phosphate, and a composition containing the title compound and N-methylmorpholine was obtained.

### Example 5

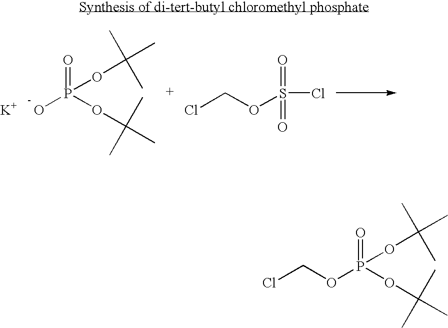

A 500 mL four-neck round bottom flask was equipped with a mechanical stirrer and a thermometer; with a nitrogen streaming, potassium di-tert-butyl phosphate (24 g), dipotassium hydrogen phosphate trihydrate (86.8 g), tetrabutylammonium hydrogen sulfate (3.23 g), tert-butyl methyl ether (112 mL) and water (54 mL) were added, and stirred while cooling with an ice bath. At an internal temperature of 15° C., a solution of chloromethyl chlorosulfonate (23.5 g) dissolved in tert-butyl methyl ether (23.6 mL) was added thereto dropwise over two hours at an internal temperature of 30° C. or lower. After dropwise addition was terminated, stirring was carried out for two hours, water (84 mL) and tert-butyl methyl ether (112 mL) were added to a separating funnel, and the above-mentioned reaction solution was added thereto. The lower layer was discarded, the organic layer was washed with an aqueous solution of 2M dipotassium hydrogen phosphate (84 mL), an aqueous solution of N-methylmorpholine (prepared from 1.05 mL of N-methylmorpholine and 84 mL of water), and water, then, N-methylmorpholine (1.05 mL) was added, the organic layer was concentrated in a bath set 35° C. under a reduced pressure to obtain 20 g of the title compound. (yield: 78%)

Note that the amount of N-methylmorpholine added last was 10 mol % based on di-tert-butyl chloromethyl phosphate, and a composition containing the title compound and N-methylmorpholine was obtained.

### Example 6

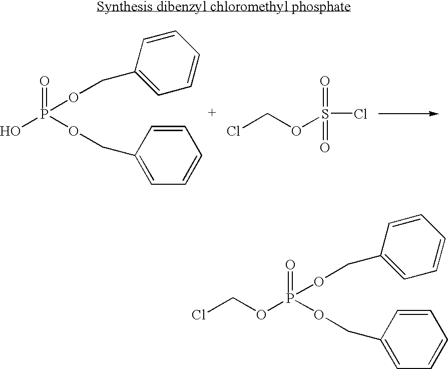

A 500 mL four-neck round bottom flask was equipped with a mechanical stirrer and a thermometer; with a nitrogen streaming, dibenzyl phosphate (20 g), sodium bicarbonate (5.9 g), dipotassium hydrogen phosphate (50 g), tetrabutylammonium hydrogen sulfate (2.4 g), tert-butyl methyl ether (94 mL) and water (72 mL) were added, and stirred while cooling with an ice bath. At an internal temperature of 15° C., a solution of chloromethyl chlorosulfonate (17.8 g) dissolved in tert-butyl methyl ether (16 mL) was added thereto over two hours at an internal temperature of 30° C. or lower. After dropwise addition was terminated, stirring was carried out for 12 hours, water (72 mL) and tert-butyl methyl ether (104 mL) were added to a separating funnel, and the above-mentioned reaction solution was added thereto. The lower layer was discarded, the organic layer was washed with an aqueous solution of 2M dipotassium hydrogen phosphate (72 mL), an aqueous solution of N-methylmorpholine (prepared from 0.8 g of N-methylmorpholine and 72 mL of water), water, and sodium chloride water, then, 0.8 g of N-methylmorpholine was added thereto followed by adding MgSO₄, the organic layer was concentrated in a bath set 35° C. under a reduced pressure to obtain 20.1 g of the title compound. (yield: 86%)

Note that the amount of N-methylmorpholine added last was 10 mol % based on dibenzyl chloromethyl phosphate, and a composition containing the title compound and N-methylmorpholine was obtained.

Evaluation of Storage Stability

Using the resulting di-tert-butyl chlorophosphate, N-methylmorpholine (NMM) and N,N-diisopropyl ethylamine (iPr₂EtN) were added at given concentrations as tertiary amines, prior to concentrating the organic layer containing the phosphate. Then, after storing at a temperature of 40° C. for 3 hours (3 hr) or 6 hours (6 hr), integration values of di-tert-butyl chlorophosphate before and after storage were measured by P-NMR measurements. Note that the storage test at 40° C. was carried out using EYELA ChemStation (temperature accuracy of ±1° C.) as thermoregulated bath.

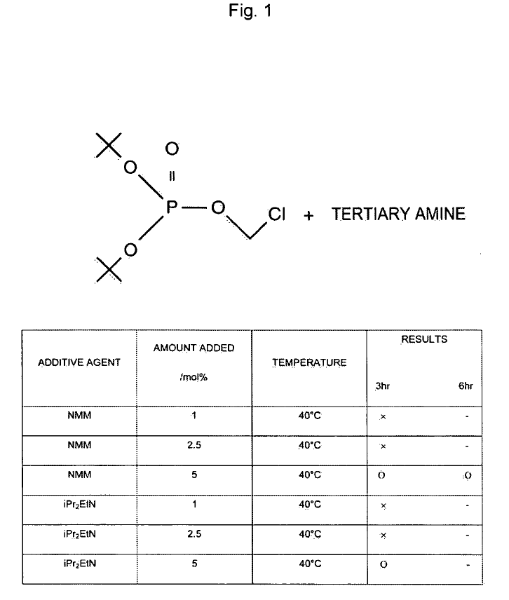

FIG. 1 shows the results of storage stability according to one aspect of the present invention. As is apparent from FIG. 1, for both NMM and iPr₂EtN, when 5 mol % is added based on di-tert-butyl chlorophosphate, no decomposition of di-tert-butyl chlorophosphate was observed, revealing that storage stability was improved. Note that, although not shown in this figure, when the amount of NMM added was 1 mol %, the amount of di-tert-butyl chlorophosphate remaining was 34% in a 40° C., 3 hours storage test, and when the amount of NMM added was 2.5 mol %, the amount of di-tert-butyl chlorophosphate remaining was 88% in a 40° C., 3 hours storage test.

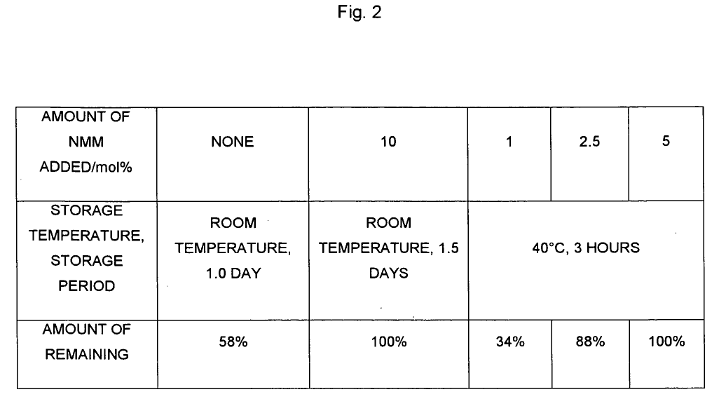

FIG. 2 shows the results when the influence on the storage stability of di-tert-butyl chlorophosphate was examined when NMM was varied, according to another aspect of the present invention. As is apparent from FIG. 2, in a 40° C., 3 hours storage test, when the amount of NMM added was 0 mol %, decomposition of di-tert-butyl chlorophosphate was observed, and the amount of remaining di-tert-butyl chlorophosphate was 34%; that is to say, it can be understood that 66% of the initial di-tert-butyl chlorophosphate decomposed. On the other hand, when the amount of NMM added was 5 mol %, in a 40° C., 3 hours storage test, decomposition of di-tert-butyl chlorophosphate was not observed. In addition, in the case where the amount of NMM added was 10 mol %, even with a storage at room temperature for 1.5 days, no decomposition of di-tert-butyl chlorophosphate was observed.

### INDUSTRIAL APPLICABILITY

According to the production process of the present invention, the chloromethyl phosphate derivative can be produced without using highly toxic reagent or halogen-based solvent, which is excellent from the points of view of workability, operativity and energy saving, thus, the production process is useful industrially. In addition, according to the present invention, stabilization of the chloromethyl phosphate derivative can be realized by adding tertiary amine to the chloromethyl phosphate derivative applicable to the production of the water-soluble prodrug, a stable supply of said derivative becomes possible, which is beneficial to industrial production of the water-soluble prodrug.

1. A composition comprising:
(A) a compound represented by the following Formula (I); and 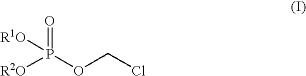
(wherein R1 and R2 are identical or different from each other, and represent a C1-C6 alkyl group, a C2-C6 alkenyl group or a C6-C 14 aryl C1-C6 alkyl group which may have a substituent, and R1 and R2 may together form a ring)
(B) a tertiary amine.

2. The composition according to claim 1, wherein said tertiary amine is trialkylamine or N-alkylmorpholine.

3. The composition according to claim 1 or 2, wherein said tertiary amine is triethylamine, N,N-diisopropylethylamine or N-methylmorpholine.

4. The composition according to claim 1, wherein at least 5 mol % of said tertiary amine is contained based on said compound represented by Formula (I).

5. The composition according to claim 1, wherein said R1 and R2 are identical or different from each other, and represent an n-butyl group, an iso-butyl group, a tert-butyl group, a vinyl group, an allyl group or a benzyl group which may have a substituent.

6. The composition according to claim 1, wherein said R1 and R2 are identical or different from each other, and represent a tert-butyl group, an allyl group or a benzyl group.

7. A process for producing a composition comprising a compound represented by the following Formula (I) and a tertiary amine, 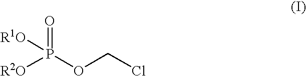
(wherein R1 and R2 are identical or different from each other, and represent a C1-C6 alkyl group, a C2-C6 alkenyl group or a C6-C14 aryl C1-C6 alkyl group which may have a substituent, and R1 and R2 may together form a ring),
the process comprising adding said tertiary amine to said compound represented by Formula (I).

8. The production method according to claim 7, wherein at least 5 mol % of said tertiary amine is added based on said compound represented by Formula (I).

9. The process according to claim 7 or 8, wherein said compound represented by Formula (I) is obtained by
(i) reacting paraformaldehyde and chlorosulfonic acid in the presence of thionyl chloride to obtain chloromethyl chlorosulfonate, and
(ii) reacting, in a solvent containing a phase-transfer catalyst and a base, said chloromethyl chlorosulfonate and a compound represented by the following Formula (II): 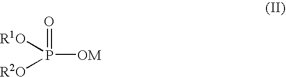
(wherein R1 and R2 are identical or different from each other, and represent a C1-C6 alkyl group, a C2-C6 alkenyl group or a C6-C 14 aryl C1-C6 alkyl group which may have a substituent, R1 and R2 may together form a ring, and M represents a hydrogen atom or an alkaline metal).

10. The process according to claim 9, wherein said solvent is an ether-based solvent.

11. The process according to claim 10, wherein said ether-based solvent is cyclopentyl methyl ether or tert-butyl methyl ether.

12. The process according to claim 9, wherein said phase-transfer catalyst is tetrabutylammonium hydrogen sulfate, and said base is dipotassium hydrogen phosphate or sodium bicarbonate.

13. A method for stabilizing a compound represented by the following Formula (I): 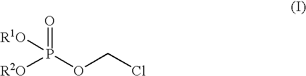
(wherein R1 and R2 are identical or different from each other, and represent a C1-C6 alkyl group, a C2-C6 alkenyl group or a C6-C14 aryl C1-C6 alkyl group which may have a substituent, and R1 and R2 may together form a ring),
the method comprising adding a tertiary amine to said compound represented by Formula (I).

14. The method according to claim 13, wherein at least 5 mol % of said tertiary amine is added based on said compound represented by Formula (I).
